(19) United States
(12) Patent Application Publication
(10) Pub. No.: US 2012/0002145 A1
(43) Pub. Date: Jan. 5, 2012

(54) SYSTEM FOR DISPLAYING IMAGES

(75) Inventors: Chien-Feng LEE, Fengshan City (TW); Hsin-Hsu SHEN, Toufen Township (TW); Hung-Yi LUO, Sanchong City (TW); Hui-Ju HSU, Huwei Township (TW)

(73) Assignee: CHIMEI INNOLUX CORPORATION, Chu-Nan (TW)

(21) Appl. No.: 13/082,276

(22) Filed: Apr. 7, 2011

Related U.S. Application Data
(60) Provisional application No. 61/361,279, filed on Jul. 2, 2010.

(30) Foreign Application Priority Data
Oct. 19, 2010 (TW) 99135515

(51) Int. Cl. G02F 1/1335

(52) U.S. Cl. 349/106

(57) ABSTRACT

A system for displaying images includes a liquid crystal display panel including an array substrate. A color filter substrate is oppositely disposed to the array substrate and has a display region, a seal region surrounding the display region, and an edge region surrounding the seal region. A first transparent conductive pattern layer covers the display region of the color filter substrate to expose the seal region and the edge region, and faces the array substrate. A seal material layer is interposed between the array substrate and the color filter substrate and corresponds to the seal region, such that the seal material layer contacts at least a portion of the color filter substrate in the exposed seal region.

### CROSS REFERENCE TO RELATED APPLICATIONS

This application claims the benefit of U.S. Provisional application No. 61/361,279, filed Jul. 2, 2010, the entirety of which is incorporated by reference herein, and this Application claims priority of Taiwan Patent Application No.099135515, filed on Oct. 19, 2010, the entirety of which is incorporated by reference herein.

### BACKGROUND OF THE INVENTION

1. Field of the Invention

The invention relates to flat panel display (FPD) technology, and in particular to a liquid crystal display panel, which is capable of hindering the peeling of layers due to poor adhesion of the seal material layer.

2. Description of the Related Art

Recently, with the development and wide application of electronic products such as mobile phones, PDAs, and notebook computers, there has been increasing demand for flat panel displays (FPDs) which consume less electric power and occupy less space.

A liquid crystal display (LCD) is one type of flat panel display and typically includes an array substrate, a color filter substrate and a liquid crystal layer interposed therebetween. FIG. 1 illustrates a partial cross section view of a conventional liquid crystal display panel. The liquid crystal display panel 10 includes a color filter substrate 12, an array substrate 14 and a liquid crystal layer 20 interposed therebetween. The color filter substrate 12 has a display region 12a, a seal region 12b and an edge region 12c arranged from the inside to the outside. Moreover, the array substrate 14 and the color filter substrate 12 are attached together by a seal material layer 18 corresponding to the seal region 12b, so as to form a liquid crystal cell therebetween for placement of the liquid crystal layer 20. A transparent conductive layer 16 serving as a common electrode typically covers the color filter substrate 12, and extends from the display region 12a to the seal region 12b and the edge region 12c. However, due to poor adhesion between the transparent conductive layer 16 and the seal material layer 18, the transparent conductive layer 16 may easily peel off of the seal material layer 18, resulting in the separation of the color filter substrate 12 from the array substrate 14, thereby reducing the yield of the liquid crystal display panel 10.

Accordingly, there exists a need in the art for development of a novel liquid crystal display panel structure, which is capable of mitigating the deficiencies mentioned above.

### BRIEF SUMMARY OF THE INVENTION

A detailed description is given in the following embodiments with reference to the accompanying drawings. Systems for displaying images are provided. An exemplary embodiment of a system for displaying images includes a liquid crystal display panel including an array substrate. A color filter substrate is oppositely disposed to the array substrate and has a display region, a seal region surrounding the display region, and an edge region surrounding the seal region. A first transparent conductive pattern layer covers the display region of the color filter substrate to expose the seal region and the edge region, and faces the array substrate. A seal material layer is interposed between the array substrate and the color filter substrate and corresponds to the seal region, such that the seal material layer contacts at least a portion of the color filter substrate in the exposed seal region.

### BRIEF DESCRIPTION OF DRAWINGS

The invention can be more fully understood by reading the subsequent detailed description and examples with references made to the accompanying drawings, wherein:

FIG. 1 is a partial cross section view of a conventional liquid crystal display panel;

FIG. 2A is a partial cross section view of an embodiment of a system for displaying images, including an LCD panel, according to the invention;

FIG. 2B is a plan view of the exemplary embodiment of the color filter substrate having the transparent conductive pattern layer shown in FIG. 2A;

FIG. 3A is a partial cross section view of an embodiment of a system for displaying images, including an LCD panel, according to the invention;

FIG. 3B is a plan view of the exemplary embodiment of the color filter substrate having the transparent conductive pattern layer shown in FIG. 3A;

FIG. 4A is a partial cross section view of an embodiment of a system for displaying images, including an LCD panel, according to the invention;

FIG. 4B is a plan view of the exemplary embodiment of the color filter substrate having the transparent conductive pattern layer shown in FIG. 4A;

FIG. 5A is a partial cross section view of an embodiment of a system for displaying images, including an LCD panel, according to the invention;

FIG. 5B is a plan view of the exemplary embodiment of the color filter substrate having the transparent conductive pattern layer shown in FIG. 5A; and

FIG. 6 schematically shows another embodiment of a system for displaying images.

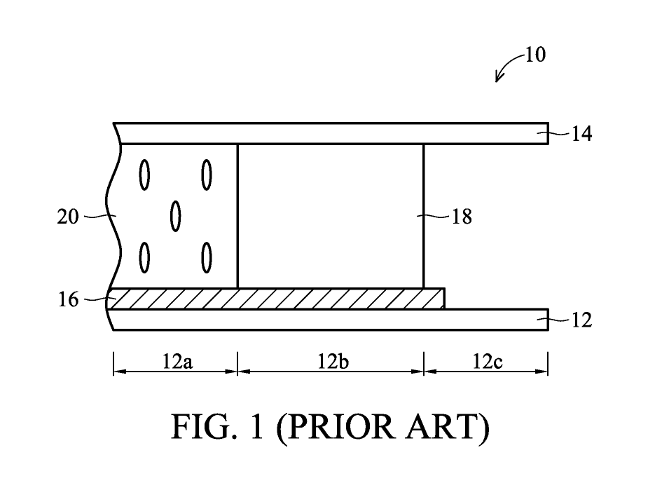

### DETAILED DESCRIPTION OF INVENTION

The following description is of the best-contemplated mode of carrying out the invention. This description is provided for the purpose of illustrating the general principles of the invention and should not be taken in a limiting sense. The scope of the invention is best determined by reference to the appended claims.

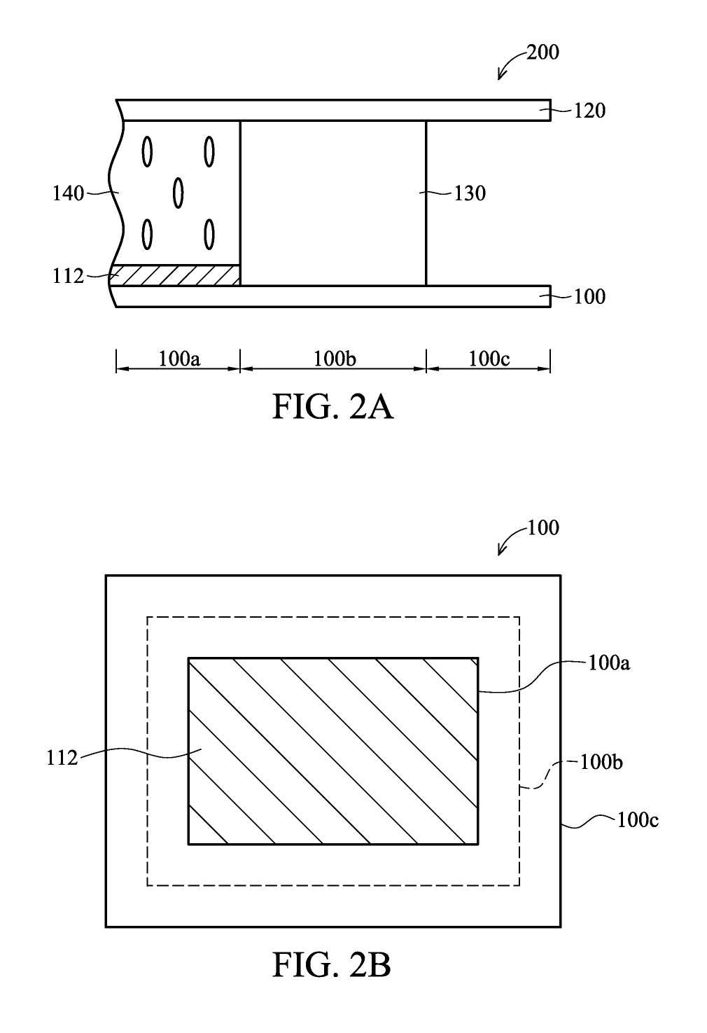

Systems for displaying images are provided. Referring to FIGS. 2A and 2B, in which FIG. 2A is a partial cross section view of an embodiment of a system for displaying images, including an LCD panel, according to the invention and FIG. 2B is a plan view of the exemplary embodiment of the color filter substrate having the transparent conductive pattern layer shown in FIG. 2A. In the embodiment, the liquid crystal display panel 200 may comprise an array substrate 120, a color filter substrate 100, and a seal material layer 130. The array substrate typically comprises a thin film transistor (TFT) array. In order to simplify the diagram, only a flat substrate is depicted. Moreover, the color filter substrate 100 has a display region 100a, a seal region 100b, and an edge region 100c, in which the display region 100a is surrounded by the seal region 100b, and the seal region 100b is surrounded by the edge region 100c, as shown in FIG. 2B.

The seal material layer 130 may comprise organic materials, such as thermosetting epoxy or light-cured resin, and is disposed between the color filter substrate 100 and the array substrate 120 and corresponds to the seal region 100b of the color filter substrate 100. The array substrate 120 and the color filter substrate 100 are attached together by the seal material layer 130 corresponding to the seal region 100b, so as to form a liquid crystal cell therebetween for placement of the liquid crystal layer 140.

A transparent conductive pattern layer 112 is disposed on the color filter substrate 100 and faces the array substrate 120 to serve as a common electrode of the liquid crystal display panel 200. In one embodiment, the transparent conductive pattern layer 112 may comprise indium tin oxide (ITO). In another embodiment, the transparent conductive pattern layer 112 may comprise indium zinc oxide (IZO) or zinc oxide (ZnO). Particularly, in the embodiment, the transparent conductive pattern layer 112 is only disposed on the color filter substrate 100 in the display region 100a to entirely expose the color filter substrate 100 in the seal region 100b and the edge region 100c, such that the seal material layer 130 can contact the color filter substrate 100 in the exposed seal region 100b.

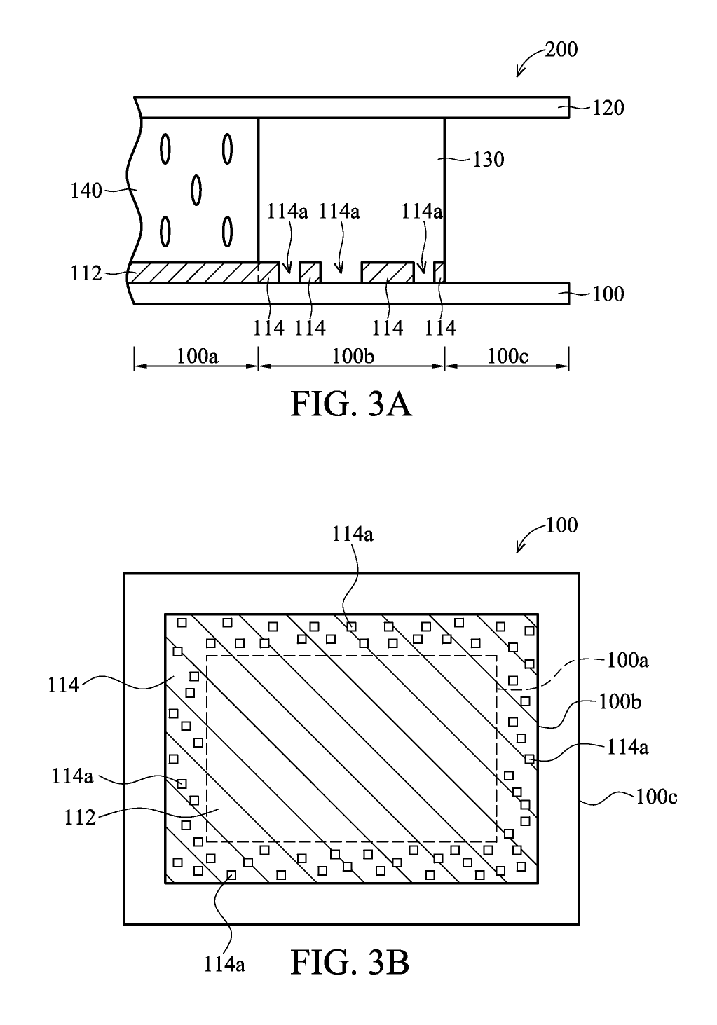

Referring to FIGS. 3A and 3B, in which FIG. 3A is a partial cross section view of an embodiment of a system for displaying images, including an LCD panel, according to the invention and FIG. 3B is a plan view of the exemplary embodiment of the color filter substrate having the transparent conductive pattern layer shown in FIG. 3A. Elements in FIGS. 3A and 3B that are the same as those in FIGS. 2A to 2B are labeled with the same reference numbers as in FIGS. 2A to 2B and are not described again for brevity. In the embodiment, the difference with the embodiment shown in FIGS. 2A to 2B is that a transparent conductive pattern layer 114 is disposed on the color filter substrate 100 and corresponds to the seal region 100b of the color filter substrate 100, except for the transparent conductive pattern layer 112 in the display region 100a. Moreover, the transparent conductive pattern layer 114 is connected to at least a portion of the transparent conductive pattern layer 112. In one embodiment, the transparent conductive pattern layer 114 and the transparent conductive pattern layer 112 may be formed of the same material layer. In some embodiments, the transparent conductive pattern layer 114 may be formed of a different material than that of the transparent conductive pattern layer 112 and may comprise ITO, IZO or ZnO.

Particularly, the transparent conductive pattern layer 114 comprises a plurality of openings 114a, such that the seal material layer 130 contacts portions of the color filter substrate 100 through the plurality of openings 114a. A total area ratio of the plurality of openings 114a to the seal region is in a range of 5% to 95%. In one embodiment, the opening 114a may be rectangular, as shown in FIG. 3B. In some embodiments, the opening 114a may have a circular, triangular, polygonal or irregular shape. In the embodiment, the plurality of openings 114a may have the same or different shapes and sizes. Moreover, the plurality of openings 114a may have a regular or irregular arrangement.

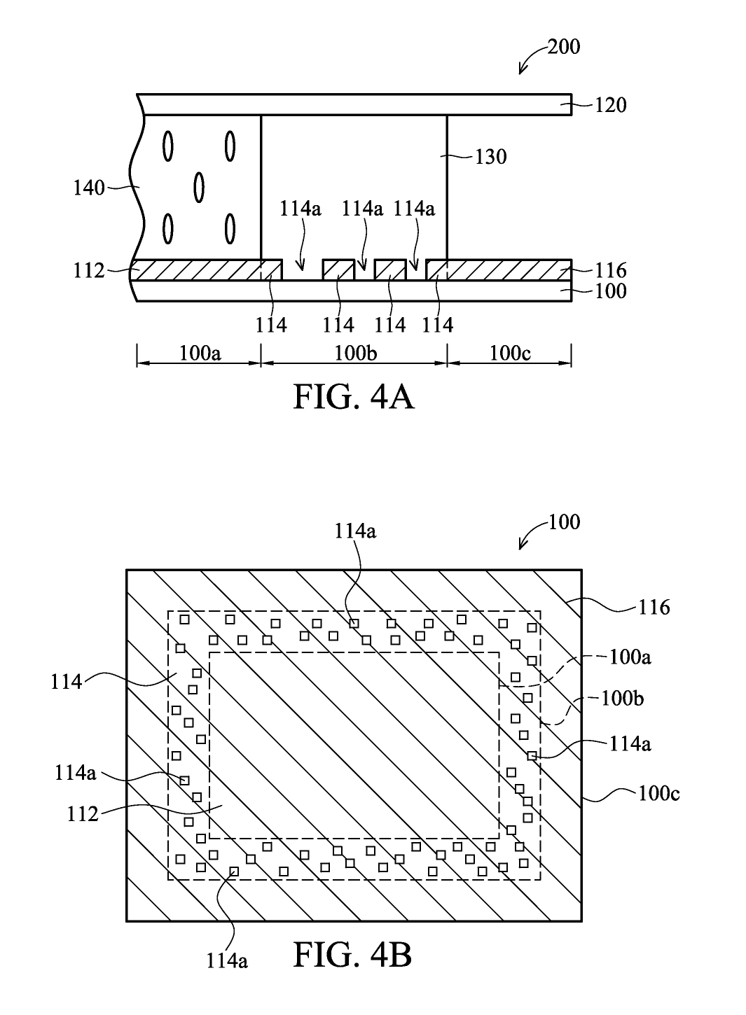

Referring to FIGS. 4A and 4B, FIG. 4A is a partial cross section view of an embodiment of a system for displaying images, including an LCD panel, according to the invention and FIG. 4B is a plan view of the exemplary embodiment of the color filter substrate having the transparent conductive pattern layer shown in FIG. 4A. Elements in FIGS. 4A and 4B that are the same as those in FIGS. 3A to 3B are labeled with the same reference numbers as in FIGS. 3A to 3B and are not described again for brevity. In the embodiment, the difference with the embodiment shown in FIGS. 3A to 3B is that a transparent conductive pattern layer 116 is disposed on the color filter substrate 100 and corresponds to the edge region 100c of the color filter substrate 100, except for the transparent conductive pattern layers 112 and 114 in the display region 100a and the seal region 100b, respectively. Moreover, the transparent conductive pattern layer 116 is connected to at least a portion of the transparent conductive pattern layer 114. In one embodiment, the transparent conductive pattern layer 116, the transparent conductive pattern layer 114, and the transparent conductive pattern layer 112 may be formed of the same material layer. In some embodiments, the transparent conductive pattern layer 116 may be formed of a different material than that of the transparent conductive pattern layer 114 and/or the transparent conductive pattern layer 112, and may comprise ITO, IZO or ZnO.

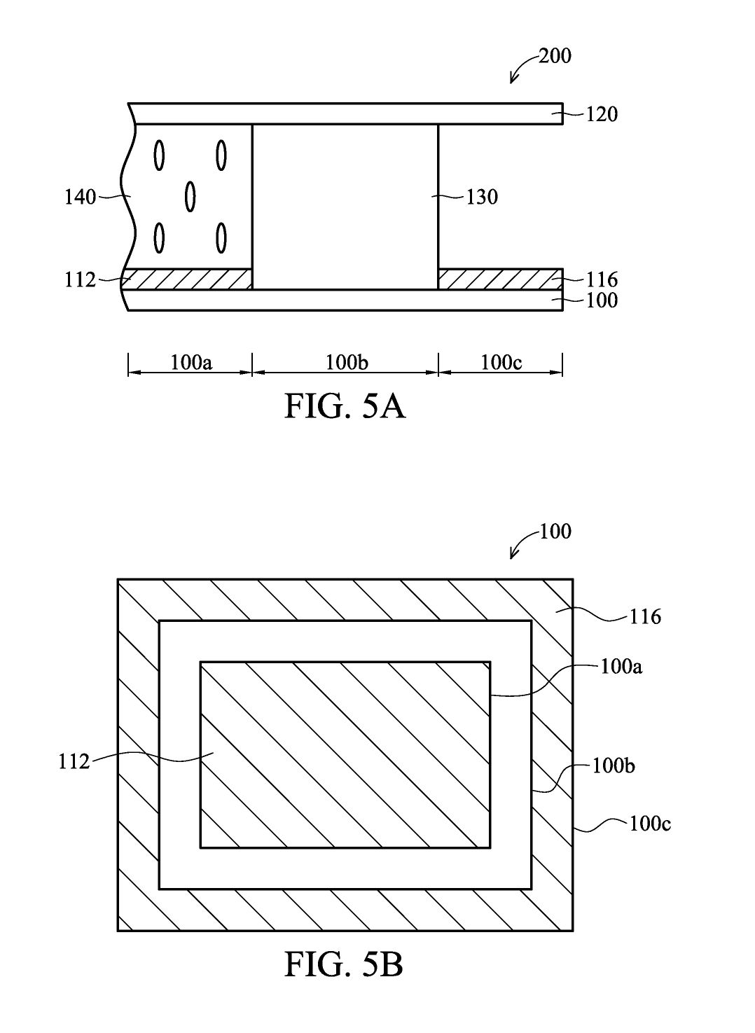

Referring to FIGS. 5A and 5B, FIG. 5A is a partial cross section view of an embodiment of a system for displaying images, including an LCD panel, according to the invention and FIG. 5B is a plan view of the exemplary embodiment of the color filter substrate having the transparent conductive pattern layer shown in FIG. 5A. Elements in FIGS. 5A and 5B that are the same as those in FIGS. 2A to 2B are labeled with the same reference numbers as in FIGS. 2A to 2B and are not described again for brevity. In the embodiment, the difference with the embodiment shown in FIGS. 2A to 2B is that a transparent conductive pattern layer 116 is disposed on the color filter substrate 100 and corresponds to the edge region 100c of the color filter substrate 100, except for the transparent conductive pattern layer 112 in the display region 100a, such that the seal material layer 130 is interposed between the transparent conductive pattern layer 112 and the transparent conductive pattern layer 116 and is capable of contacting the exposed color filter substrate 100 in the seal region 100b. In one embodiment, the transparent conductive pattern layer 116 and the transparent conductive pattern layer 112 may be formed of the same material layer. In some embodiments, the transparent conductive pattern layer 116 may be formed of a different material than that of the transparent conductive pattern layer 112 and may comprise ITO, IZO or ZnO.

According to the foregoing embodiments, since the color filter substrate 100 typically includes a color filter formed of an organic material, the adhesion between the array substrate 120 and the color filter substrate 100 can be increased due to good adhesion between the seal material layer 130 and the color filter substrate 100. Moreover, since the transparent conductive pattern layer 114 having the plurality of openings 114a can increase the contact area between the transparent conductive pattern layer 114 and the seal material layer 130, the adhesion therebetween can be increased, thereby increasing the yield of the liquid crystal display panel 200. Additionally, since the transparent conductive pattern layer extends to the seal region and/or the edge region from the display region, the electrostatic discharge (ESD) protection for the liquid crystal display panel can be further improved.

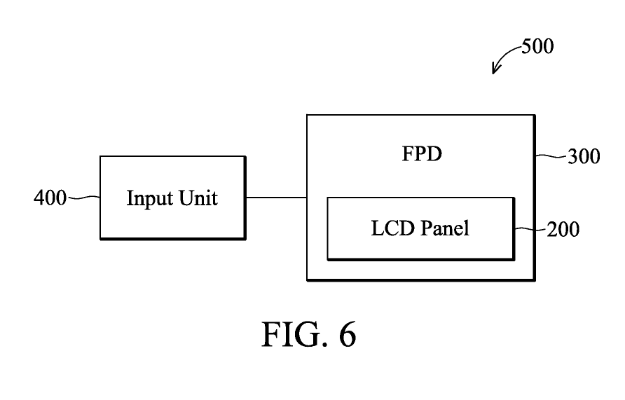

FIG. 6 schematically shows another embodiment of a system for displaying images which, in this case, is implemented as a flat panel display (FPD) 300 or an electronic device 500 such as a laptop computer, a mobile phone, a digital camera, a personal digital assistant (PDA), a desktop computer, a television, a car display or a portable DVD player. The FPD 300 may comprise the described liquid crystal display panel 200, and thus the FPD 300 may be a liquid crystal display. As shown in FIG. 6, the FPD 300 comprises the liquid crystal display panel 200 as shown in FIGS. 2 to 5. In some embodiments, the FPD 300 can be incorporated into the electronic device 500. As shown in FIG. 6, the electronic device 500 comprises the FPD 300 and an input unit 400. Moreover, the input unit 400 is coupled to the FPD 300 and is operative to provide input signals (e.g. image signals) to the FPD 300 to generate images.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system for displaying images, comprising:
a liquid crystal display panel comprising:
an array substrate;
a color filter substrate oppositely disposed to the array substrate and having a display region, a seal region surrounding the display region, and an edge region surrounding the seal region;
a first transparent conductive pattern layer covering the display region of the color filter substrate to expose the seal region and the edge region, and facing the array substrate; and
a seal material layer interposed between the array substrate and the color filter substrate and corresponding to the seal region, such that the seal material layer contacts at least a portion of the color filter substrate in the exposed seal region.

2. The system of claim 1, wherein the liquid crystal display panel further comprises a second transparent conductive pattern layer on the color filter substrate in the exposed seal region and connected to at least a portion of the first transparent conductive pattern layer, and wherein the second transparent conductive pattern layer comprises a plurality of openings, such that the seal material layer contacts the color filter substrate through the plurality of openings.

3. The system of claim 2, wherein a total area ratio of the plurality of openings to the seal region is in a range of 5% to 95%.

4. The system of claim 2, wherein the liquid crystal display panel further comprises a third transparent conductive pattern layer on the edge region of the color filter substrate and connected to at least a portion of the second transparent conductive

5. The system of claim 4, wherein the first, second, and third transparent conductive pattern layers are formed of the same material layer.

6. The system of claim 4, wherein the first, second, and third transparent conductive pattern layers comprise indium tin oxide, indium zinc oxide, or zinc oxide.

7. The system of claim 2, wherein the plurality of openings have the same or different shapes and sizes.

8. The system of claim 2, wherein the plurality of openings have a circular, triangular, rectangular, polygonal or irregular shape.

9. The system of claim 2, wherein the plurality of openings have a regular or irregular arrangement.

10. The system of claim 1, wherein the liquid crystal display panel further comprises a second transparent conductive pattern layer on the color filter substrate in the exposed edge region, such that the seal material layer is interposed between the first transparent conductive pattern layer and the second transparent conductive pattern layer.

11. The system of claim 10, wherein the first and second transparent conductive pattern layers are formed of the same material layer and comprise indium tin oxide, indium zinc oxide, or zinc oxide.

12. The system as claimed in claim 1, further comprising:
a flat panel display comprising the liquid crystal display panel; and
an input unit coupled to the flat panel display and operative to provide input singles to the flat panel display, such that the flat panel display displays images.

13. The system of claim 12, wherein the flat panel display is a liquid crystal display.

14. The system of claim 12, wherein the system is an electronic device comprising the flat panel display.

15. The system of claim 14, wherein the electronic device is a laptop computer, a mobile phone, a digital camera, a personal digital assistant, a desktop computer, a television, a car display or a portable DVD player.
